(19) United States
(12) Patent Application Publication
(10) Pub. No.: US 2025/0005409 A1
(43) Pub. Date: Jan. 2, 2025

(54) FUTURE STATE ESTIMATION APPARATUS

(71) Applicant: HITACHI, LTD., Tokyo (JP)

(72) Inventors: Yuya TOKUDA, Tokyo (JP); Tatsurou YASHIKI, Tokyo (JP); Takuya YOSHIDA, Tokyo (JP)

(21) Appl. No.: 18/710,297

(22) PCT Filed: Oct. 25, 2022
(86) PCT No.: PCT/JP2022/039595

§ 371 Date: May 15, 2024

(30) Foreign Application Priority Data
Nov. 17, 2021 (JP) 2021-187403

(51) Int. Cl. G06N 7/01; G06F 7/50; G06F 7/523

(52) U.S. Cl. CPC G06N 7/01; G06F 7/50; G06F 7/523

(57) ABSTRACT

A storage device stores a state transition model in which a first state transition probability (state transition probability function τ), which indicates the probability that a prediction subject will transition from a first state s to a second state s′ after a first time (Δt) has elapsed, is expressed by a linear combination of weighted basis functions (model storage unit). A computation device calculates a second state transition probability (attenuation-type state transition probability function D), which indicates the probability that the prediction subject will transition from the first state s to the second state s′ after a second time (Δt×∞) has elapsed, by means of a product-sum computation of a weight matrix ∇ representing a matrix the elements of which are the respective weights of the weighted basis functions (future state prediction computation unit).

### TECHNICAL FIELD

This invention relates to a future state estimation apparatus.

### BACKGROUND ART

For model predictive control which is generally applied in the fields of automobiles and plants (power generation and industry), the one which can predict further distant future of a state of an operation target tends to have higher performance. In order to predict a future state of the operation target, the following apparatuses and methods are present.

Patent Literature 1 discloses a method of predicting a future state by using a model that simulates behavior of an operation target and calculating an operation amount suitable for the future state.

Patent Literature 2 discloses a method of predicting present and future states of an industrial system as a control target and optimizing a control law so as to maximize an objective function.

Patent Literature 3 discloses a method in which a nonlinear and dynamic system such as a heat reaction furnace process is modeled by a regression method and an optimal operation amount is calculated by using a future state predicted by the model.

Patent Literature 4 relates to a control parameter automatic adjustment apparatus that can automatically optimize a control parameter according to a purpose while satisfying a constraint condition in plant operation and can shorten a calculation time required for optimization of the control parameter. A method of calculating a control law considering a future state by using a plant model and a machine learning method such as reinforcement learning is disclosed.

Patent Literature 5 discloses a method in which a state transition model that expresses behavior of an operation target as state transition probability is recorded, and calculation equivalent to an infinite series of the model is performed, so that within space in a finite and discrete state defined in advance, a future state of the operation target in infinite time ahead is rapidly estimated in a form of probability density distribution.

### CITATION LIST

### Patent Literature

Patent Literature 1: Japanese Unexamined Patent Application Publication No. 2016-212872
Patent Literature 2: Japanese Unexamined Patent Application Publication No. 2013-114666
Patent Literature 3: Japanese Unexamined Patent Application Publication No. 2009-076036
Patent Literature 4: Japanese Unexamined Patent Application Publication No. 2017-157112
Patent Literature 5: Japanese Unexamined Patent Application Publication No. 2019-159876

### SUMMARY OF INVENTION

### Technical Problem

The apparatuses and methods of Patent Literatures 1, 2, 3, and 4 predict a future state by using a model that simulates behavior of an operation target, and calculate an optimal control method from the predicted future state. The one which can predict further distant future of a state of an operation target tends to have higher performance. However, a method using iterative calculation requires a longer time for prediction calculation as time to a future state to be predicted is longer. Consequently, up to a future state in finite time ahead that can be calculated within an allowable time range is generally calculated.

In the apparatus and method of Patent Literature 5, within space in a discrete state, states of an operation target and its surrounding environment in infinite time ahead are estimated in a form of probability density distribution, but a method of estimating states of an operation target and its surrounding environment in infinite time ahead in a probability density distribution within space in a continuous state is not clarified.

Accordingly, an object of the present invention is to provide a future state estimation apparatus that can rapidly estimate a future state of a prediction target within space in a continuous state.

### Solution to Problem

In order to solve the above problems, a future state estimation apparatus of the present invention includes: a storage device that stores a state transition model in which first state transition probability representing probability in which a prediction target shifts from a first state to a second state after elapse of a first time is expressed by a linear combination of weighted basis functions; and an arithmetic device that calculates second state transition probability representing probability in which the prediction target shifts from the first state to the second state by the time after elapse of a second time, by product-sum calculation of a weighting matrix representing a matrix in which weights of the respective weighed basis functions are as elements.

### Advantageous Effects of Invention

According to the present invention, it is possible to rapidly estimate a future state of a prediction target within a space in a continuous state. Objects, configurations, and effects other than the above will be apparent from the description of the following embodiments.

### BRIEF DESCRIPTION OF THE DRAWINGS

FIG. 1 is a diagram illustrating a configuration of a processing apparatus according to First Embodiment.

FIG. 2 is a diagram schematically illustrating an arrangement of basis functions.

FIG. 3 is a diagram schematically illustrating a graph of transition probability.

FIG. 4 is a diagram schematically illustrating processing of Equation (2).

FIG. 5 is a diagram illustrating a flow of processing performed by the processing apparatus illustrated in FIG. 1.

FIG. 6 is a diagram illustrating a configuration of a processing apparatus according to Second Embodiment.

FIG. 7 is a diagram illustrating a flow of processing performed by the processing apparatus illustrated in FIG. 6.

FIG. 8 is a diagram illustrating a configuration of a first display screen according to Third Embodiment.

FIG. 9 is a diagram illustrating a configuration of a second display screen according to Third Embodiment.

FIG. 10 is a diagram illustrating a configuration of a third display screen according to Third Embodiment.

### DESCRIPTION OF EMBODIMENTS

Hereinafter, First to Third Embodiments will now be described with reference to the drawings.

### First Embodiment

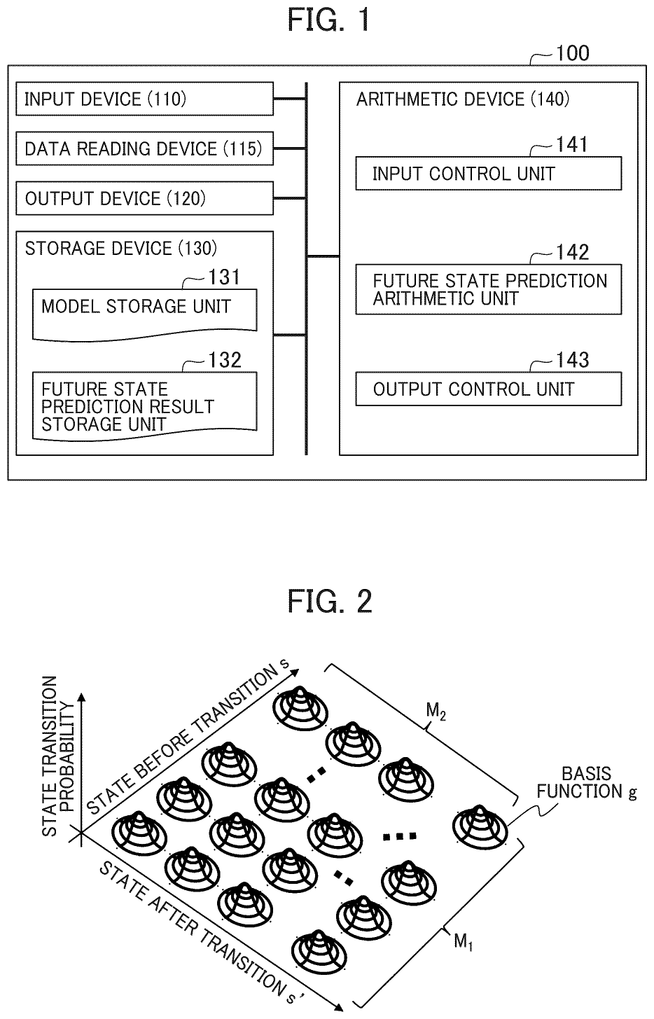

FIG. 1 is a configuration diagram illustrating an example of a processing apparatus 100 (future state estimation apparatus) according to First Embodiment of the present invention. The processing apparatus 100 includes an input device 110, a data reading device 115, an output device 120, a storage device 130, and an arithmetic device 140 as main elements.

Of these, the input device 110 is a part that receives an instruction from an operator, and includes a button, a touch panel, and the like.

The data reading device 115 is a part that receives data from the outside of the processing apparatus 100, and includes a CD drive, a USB terminal, a LAN cable terminal, a communication device, and the like.

The output device 120 is a device that outputs instruction information to an operator, a read image, a read result, and the like, and includes a display, a communication device, and the like.

These configurations described above are standard ones, and any or all of the input device 110, the data reading device 115, and the output device 120 may be connected to the outside of the processing apparatus 100.

The storage device 130 is a part that stores various types of data, and includes a model storage unit 131 and a future state prediction result storage unit 132. Of these, the model storage unit 131 is a part that stores a model that simulates behavior of an object or a phenomenon as a prediction target of a future state in the processing apparatus 100. In addition, the future state prediction result storage unit 132 is a part that stores a calculation result of a future state prediction arithmetic unit 142 described later. Details of the storage device 130 will be described later, and only schematic functions are described here.

The arithmetic device 140 processes data input from the input device 110 and the data reading device 115 and data stored in the storage device 130, outputs the result to the output device 120 or records the result in the storage device 130, and includes processing units described below (an input control unit 141, the future state prediction arithmetic unit 142, and an output control unit 143).

The input control unit 141 is a part that divides data input from the input device 110 or the data reading device 115 into instructions, models, and the like, and transfers the data to each unit of the storage device 130 and the arithmetic device 140.

The future state prediction arithmetic unit 142 calculates an attenuation type state transition probability function from model data stored in the model storage unit 131, and records the attenuation type state transition probability function in the future state prediction result storage unit 132.

The output control unit 143 is a part that outputs data stored in the storage device 130 to the output device 120. When an output destination is a screen or the like, it is preferable that a result is output each time reading operation is performed. When an output destination is a communication destination or the like, output processing may be performed each time a state transition probability matrix is updated or calculation of the future state prediction arithmetic unit 142 is performed, or may be performed in such a manner that pieces of data of a plurality of times are collected, pieces of data are collected at predetermined time intervals, or the like.

It should be noted that the arithmetic device 140 is comprised of, for example, a processor such as a CPU (Central Processing Unit), and the storage device 130 includes, for example, an HDD (Hard Disk Drive) or an SSD (Solid State Drive) or a memory and the like. The processor executes a program stored in the memory and the like, so that the processor and the memory cooperate to achieve various functions described later.

Hereinafter, details of processing executed by using the processing apparatus 100 of FIG. 1 will be described. It should be noted that, in description hereinafter, the object or the phenomenon as the prediction target of the future state will be referred to as a simulation target in the present embodiment. Examples of the simulation targets include behavior of machines and living things, natural and physical phenomena, chemical reactions, changes in money and prices, changes in consumer demand, and the like. However, the simulation targets are not limited to these examples in the present embodiment.

Input of a model in the present embodiment is a state of the simulation target and elapse of time, and influencing factors such as operation and disturbance, and output is a state of the simulation target after being influenced by the influencing factors. In the present embodiment, this model will be referred to as a state transition model. Models such as the state transition model are stored in the model storage unit 131 of FIG. 1. In addition, the state transition model expresses the state of the simulation target in infinite time or an infinite step ahead within finite state space in a form of probability density distribution.

A storage format of the state transition model and the like in the model storage unit 131 is a format of a linear combination of weighted functions, and as an example of the storage format of the state transition model and the like in the model storage unit 131, for example, a state transition probability matrix, a neural network, a radial basis function network, or a matrix or a vector that expresses a weight of a neural network or a radial basis function network can be considered. However, the present embodiment does not limit the model storage format of the simulation target to these examples.

A weight of the weighted function may be set in advance according to the behavior of the simulation target, or may be automatically estimated from time series data recording the behavior of the simulation target by using, for example, an optimization method such as a neural network.

An example in a case where the format of the model stored in the model storage unit 131 is a radial basis function network in which a noncorrelation normal distribution is a basis function is shown in Equation (1) below.

$$\begin{matrix}[ Equation 1 ] & \\ τ ( s , {s}^{'} ) ≡ {\sum }_{i}^{{M}_{1}} {\sum }_{j}^{{M}_{2}} {λ}_{i j} g ( s , {s}^{'} , {μ}_{i} , {{μ}^{'}}_{j} , {σ}_{i} , {{σ}^{'}}_{j} ) = Λ : G & ( 1 )\end{matrix}$$

In Equation (1), τ is the state transition probability function, s is a state before operation is added to an operation target (state before transition), s′ is a state after operation is added to an operation target (state after transition), M1 is the number of the basis function in the direction of the state before transition s, M2 is the number of the basis function in the direction of the state after transition s′, μi (i=1, 2, 3, . . . , M1) and μ′j (j=1, 2, 3, . . . , M2) are average values, σi (i=1, 2, 3, . . . , M1) and σ′j (j=1, 2, 3, . . . , M2) are distribution values, Δij is a weight of the basis function, Λ is a matrix that stores the weight Δij of the basis function, and G is a matrix that stores a normal distribution function that is the basis function.

FIG. 2 is a diagram schematically illustrating arrangement of basis functions of Equation (1). In the case of FIG. 2, there are M1×M2 basis functions, and the state transition probability τ (s, s′) is expressed by a linear combination of products of the basis functions and their weights.

In addition, the state transition probability function τ is generally a kind of a model that simulates a motion characteristic and a physical phenomenon of a control target, and is a function that stores transition probability between all states. Output of the function τ is probability P (s′₁, s′₂, . . . , s′_{N}|s₁, s₂, . . . , s_{N}) of transition from the state before transition si (i=1, 2, . . . , N) to the state after transition s′i (i=1, 2, . . . , N) when a step time Δt (or step) set in advance elapses. It should be noted that the example of Equation (1) is a calculation formula that assumes N=1.

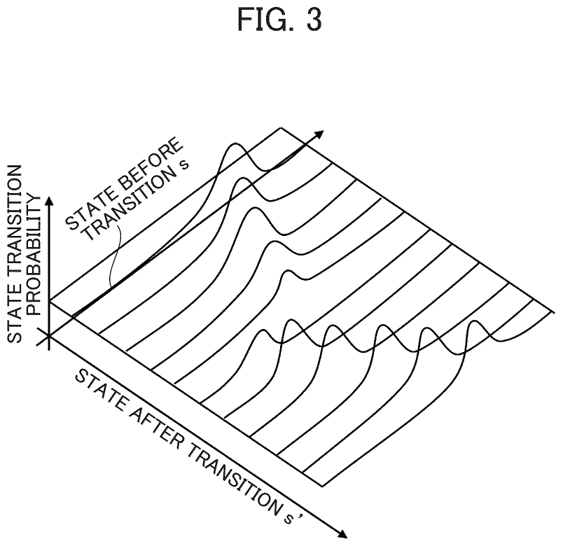

FIG. 3 is a diagram schematically illustrating a graph of transition probability in which products of basis functions arranged as in FIG. 2 and their weights are linearly combined. In the graph, the probability P (s′₁|s₁) from each state before transition s to around the state after transition s′ having the highest transition frequency is high, and on the contrary, the probability P (s′₁|s₁) around the state after transition s′ having a low transition frequency is low.

The simulation target to which the present embodiment is applied may be one in which a calculation time does not depend on any one or more of a distance, time, and a step to a future state estimated when states of the simulation target and its surrounding environment in infinite time or an infinite step ahead are estimated in a form of probability density distribution. In a case where the state transition probability P (s′₁, s′₂, . . . , s′_{N}|s₁, s₂, . . . , s_{N}) does not depend on time, a step u that represents an amount and the number of times in which the influencing factor interferes with the simulation target may be used instead of time t.

Returning to FIG. 1, the future state prediction result storage unit 132 is a part that stores the calculation result of the future state prediction arithmetic unit 142. In the present embodiment, the data stored in the future state prediction result storage unit 132 will be referred to as a state transition probability series sum matrix. The state transition probability series sum matrix and its calculation method will be described later.

The future state prediction arithmetic unit 142 calculates the state transition probability series sum matrix from the model data recorded in the model storage unit 131, and records the state transition probability series sum matrix in the future state prediction result storage unit 132. An example of a method of calculating the state transition probability series sum matrix is shown in Equation (2) below. It should be noted that in the example of Equation (2), the storage format of the model in the model storage unit 131 is assumed as the state transition probability function τ.

$$\begin{matrix}[ Equation ( 2 ) ] & \\ D ( s , {s}^{'} ) = τ + {γτ}^{( 2 )} + {γ}^{2} {τ}^{( 3 )} + … + {γ}^{L - 1} {τ}^{( L )} + … + {γ}^{∞ - 1} {τ}^{( ∞ )} & ( 2 )\end{matrix}$$

In Equation (2), D is an attenuation type state transition probability function, and γ is a constant of 0 or more and less than 1 referred to as an attenuation rate. In addition, τ(L) is a function (or matrix) that stores transition probability between all states when the time of Δt×L elapses.

It should be noted that an example of a method of calculating τ(L) is shown in Equation (3) below.

$$\begin{matrix}[ Equation ( 3 ) ] & \\ {τ}^{( L )} ( [ s , {s}^{'} ] ) = {\int }_{- ∞}^{∞} … {\int }_{- ∞}^{∞} \{ τ ( [ s , {k}_{1} ] ) … τ ( [ {k}_{L - 1} , {s}^{'} ] ) \} d {k}_{1} … {dk}_{L - 1} & ( 3 )\end{matrix}$$

In Equation (3), kl (1=1, 2, . . . , L−1) is a state that passes from the state before transition s to the state after transition s′. Transition probability at τ(L) is the product of a result obtained by integration with respect to the state kl that passes through the state transition probability function τ.

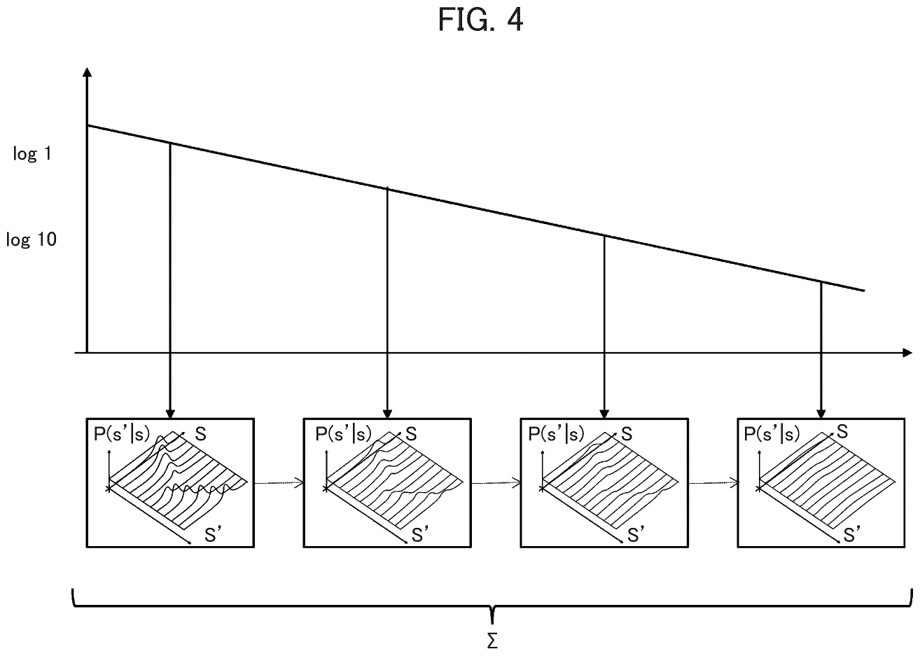

FIG. 4 is a diagram schematically illustrating processing of Equation (2), in which a plurality of state transition probability functions τ(s, s′) at each of the elapsed time Δt are multiplied by the attenuation rate γ that attenuates at each of the elapsed time Δt, and the total of them is calculated.

In this way, the attenuation type state transition probability function D is the sum of the state transition probability function τ after elapse of the time of Δt to the state transition probability function τ∞ after elapse of the time of Δt×∞ and is also a matrix that stores statistical proximity between all states. In addition, in order to reduce a weight for a state of transition to a more distant future, a large amount of the attenuation rate γ is multiplied according to the elapsed time.

With Equation (2), which requires calculation from the state transition probability function τ at a current time point to the state transition probability function τ∞ after the time of ∞ elapses, calculation within real time is difficult. In view of the above, the present embodiment is characterized in that Equation (2) is converted to Equation (4) below. In short, Equation (4) is for performing calculation equivalent to the series of the state transition probability matrix when states of the simulation target and its surrounding environment in infinite time or an infinite step ahead are estimated in the form of probability density distribution.

$$\begin{matrix}[ Equation ( 4 ) ] & \\ D ( s , {s}^{'} ) = {Λ ( E - {γ}^{t} ΨΛ )}^{- 1} : G & ( 4 )\end{matrix}$$

In Equation (4), E is a unit matrix, ψ is a conversion matrix, and tψ is a transposition matrix of the conversion matrix ψ. Equation (4) is a calculation formula equivalent to Equation (2). By converting the calculation of the sum of the state transition probability function τ to the state transition probability function τ∞ in Equation (2) into an inverse matrix of (E-γψ transposition A) in Equation (4), the same calculation result as Equation (2) is obtained within finite time. Here, in a case where the conversion matrix ψ is not linearly independent, a pseudo inverse matrix may be used. It should be noted that an example of a method of calculating the conversion matrix ψ is shown in Equation (5) below.

$$\begin{matrix}[ Equation ( 5 ) ] & \\ {Ψ}_{ij} = {\int }_{- ∞}^{∞} g ( k , k , {μ}_{j} , {{μ}^{'}}_{i} , {σ}_{j} , {{σ}^{'}}_{i} ) dk & ( 5 )\end{matrix}$$

The conversion matrix ψ is an integration value of a normal distribution as a basis function, and is a constant that does not depend on the state before transition s and the state after transition s′.

In this way, the present embodiment makes it possible to calculate the state transition probability after the time of Δt×L by calculating τ(L) by using the model that simulates the behavior of the simulation target as the state transition model. In addition, the sum of the state transition probability function τ after elapse of the time of Δt to the state transition probability function τ(∞) after elapse of the time of Δt×∞ is taken, and weighting is performed with the attenuation rate γ according to the elapsed time, so that the state transition probability in consideration of elapse of the time of Δt×∞ can be calculated within finite time.

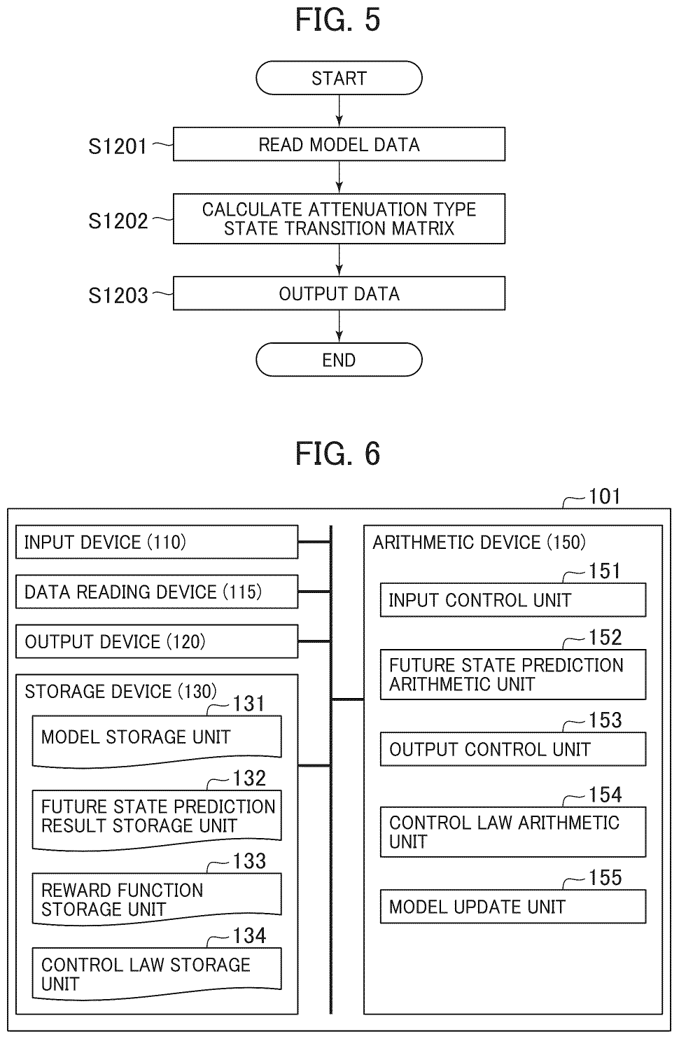

FIG. 5 is a diagram illustrating a flow of processing performed by the processing apparatus 100.

First, by processing in processing step S1201, data regarding the model of the simulation target is input from the data reading device 115 based on an instruction from the input control unit 141, and the data is recorded in the model storage unit 131.

Next, by processing in processing step S1202, the data regarding the model of the simulation target recorded in the model storage unit 131 is transferred to the future state prediction arithmetic unit 142, the attenuation type state transition probability function D is calculated based on Equation (4), and the result is recorded in the future state prediction result storage unit 132.

Finally, by processing in processing step S1203, the data recorded in the future state prediction result storage unit 132 is transferred to the output control unit 143, and is output to the output device 120.

### Second Embodiment

FIG. 6 is a configuration diagram illustrating an example of the processing apparatus 101 obtained by expanding the processing apparatus 100 of First Embodiment to optimize model-based control. The simulation target in the processing apparatus 101 is behavior of the control target and its surrounding environment, and the model stored in the model storage unit 131 also simulates the behavior of the control target and its surrounding environment. In this way, in Second Embodiment, a case where the simulation target includes the control target is assumed.

The processing apparatus 101 includes the input device 110, the data reading device 115, the output device 120, the storage device 130, and an arithmetic device 150 as main elements.

Of these, the input device 110 is a part that receives an instruction from an operator, and includes a button, a touch panel, and the like.

The data reading device 115 is a part that receives data from the outside of the processing apparatus 100, and includes a CD drive, a USB terminal, a LAN cable terminal, a communication device, and the like.

The output device 120 is a device that outputs instruction information to an operator, a read image, a read result, and the like, and includes a display, a CD drive, a USB terminal, a LAN cable terminal, a communication device, and the like.

These configurations described above are standard ones, and any or all of the input device 110, the data reading device 115, and the output device 120 may be connected to the outside of the processing apparatus 100.

The storage device 130 includes the model storage unit 131, the future state prediction result storage unit 132, a reward function storage unit 133, and a control law storage unit 134. Of these, the future state prediction result storage unit 132 has substantially the same function as that of First Embodiment.

There is a case where the model storage unit 131 has the same function as that of First Embodiment, and there is also a case where the behavior of the simulation target changes not only in the state but also in the operation amount in control. In a case where the behavior of the simulation target changes according to the operation amount, the attenuation type state transition can be calculated as in First Embodiment by adding information of the operation amount to the model.

The reward function storage unit 133 is a part that stores the control target such as a target position and a target speed in the form of a function, a table, a vector, a matrix, and the like. In the present embodiment, the function, the table, the vector, the matrix, and the like having information of this control target will be referred to as a reward function r. In the present embodiment, an output value of this reward function R will be referred to as a reward r.

An example of a case where the reward function is in a function format is shown in Equation (6).

$$\begin{matrix}[ Equation 6 ] & \\ R ( {s}^{'} ) = g ( {s}^{'} , {μ}_{r} , {σ}_{r} ) & ( 6 )\end{matrix}$$

It should be noted that μr is a target state, and σr is target distribution. The reward function R of Equation (6) is a normal distribution regarding the state after transition s′ having a feature in which the reward r is maximum in the target state μr and the smaller reward r is output as it is separated from the target state μr. A range of a state that obtains the high reward r is adjusted by the target distribution σr. It should be noted that as the reward for control, a desired value or an objective function at the time of reinforcement learning in AI (Artificial Intelligence) is exemplified.

Returning to FIG. 6, the control law storage unit 134 is a part that stores an optimal control law for the control target. An example of the control law stored in the control law storage unit 134 is shown in Equation (7).

$$\begin{matrix}[ Equation 7 ] & \\ X ( s ) = {arg max}_{a} \int V ( {s}^{'} ) P ( {s}^{'} \vert s , a ) d {s}^{'} & ( 7 )\end{matrix}$$

It should be noted that X is the control law, V is a value function, P is the state transition probability, and a is the operation amount. The value function V is a function that stores proximity to a state sgoal as a target (or a statistical index representing the likeliness of transition). A calculation method of the value function V will be described later. Equation (7) stores, of all operation amounts a, the operation amount a in which a value obtained by integrating the product of the value function V and the state transition probability P for the state after transition s′ is maximum.

Returning to FIG. 6, the arithmetic device 150 processes data input from the input device 110 and the data reading device 115 and data stored in the storage device 130, outputs the result to the output device 120 or records the result in the storage device 130, and includes processing units described below.

An input control unit 151 is a part that divides data input from the input device 110 or the data reading device 115 into instructions, models, and the like, and performs processing for transferring the data to each unit of the storage device and the arithmetic device.

A future state prediction arithmetic unit 152 is equivalent to the future state prediction arithmetic unit 142 of First Embodiment. In addition, an output control unit 153 is also equivalent to the output control unit 143 of First Embodiment.

A control law arithmetic unit 154 calculates the optimal control law (optimal operation amount a) from the attenuation type state transition probability function D recorded in the future state prediction result storage unit 132 and the reward function R recorded in the reward function storage unit 133, and records the optimal control law in the control law storage unit 134.

An example of a method of calculating the optimal control law is shown below. In this example, calculation is performed in two stages below in order to obtain the optimal control law.

Stage 1: First, the value function V is calculated by the attenuation type state transition probability function D and the reward function R. The value function V may be stored in the form of a table, a vector, a matrix, and the like other than a function, and in the present embodiment, the storage format is not limited. An example of a calculation method of the state value function V is shown in Equation (8) below.

$$\begin{matrix}[ Equation 8 ] & \\ V ( s ) = \int D ( s , {s}^{'} ) R ( {s}^{'} ) d {s}^{'} & ( 8 )\end{matrix}$$

As shown in Equation (8), the value function V is a function that integrates the product of the attenuation type state transition probability function D and the reward function R for the state after transition s′. A value of the value function V is higher in a state where transition to the state sgoal as a target is more likely. In the present embodiment, an output of this value function V will be referred to as a value. In addition, the value function V of the present embodiment is equivalent in value to the definition of a state value function in a reinforcement learning method.

Step 2: Next, by using the value function V, the optimal operation amount a is calculated in the state before transition s at present. For calculation of the optimal operation amount a, Equation (7) above is used.

Calculation of the value with Equation (8) above in this way enables evaluation of the likeliness of transition to the sgoal in each state, and Equation (7) above enables identification of the optimal operation amount a.

Returning to FIG. 6, a model update unit 155 modifies model data based on update data when the update data of the model data recorded in the model storage unit 131 is input from the data reading device 115, and records the modified model data in the model storage unit 131.

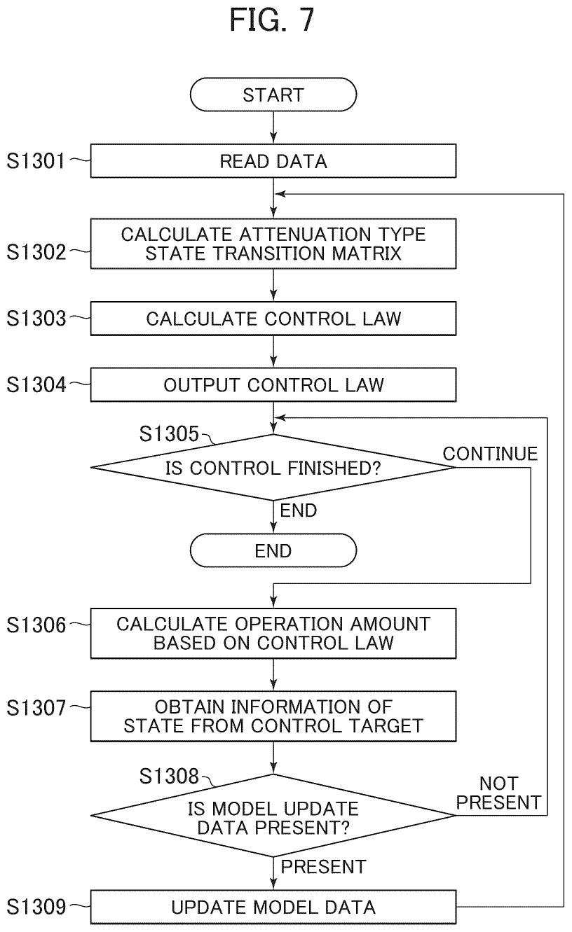

FIG. 7 is a diagram illustrating a flow of processing performed by the processing apparatus 101.

First, in processing step S1301 of FIG. 7, data regarding the model of the simulation target and data regarding the reward function R are input from the data reading device 115 based on an instruction from the input control unit 141, and the pieces of the data are recorded in the model storage unit 131 and the reward function storage unit 133.

Next, in processing step S1302, the data regarding the model of the simulation target recorded in the model storage unit 131 is transferred to the future state prediction arithmetic unit 142, the attenuation type state transition probability function D is calculated based on Equation (4), and the result is recorded in the future state prediction result storage unit 132.

Next, in processing step S1303, the attenuation type state transition probability function D recorded in the future state prediction result storage unit 132 and the reward function R recorded in the reward function storage unit 133 are transferred to the control law arithmetic unit 154, an optimal control law is calculated, and the result is recorded in the control law storage unit 134.

Next, in processing step S1304, the pieces of the data recorded in the future state prediction result storage unit 132 and the control law storage unit 134 are transferred to the output control unit 143 and output to the output device 120.

Next, in processing step S1305, it is determined whether or not the control of the control target is finished. In a case where the control is to be continued, the flow proceeds to processing step S1306, and in a case where the control is to be finished, the flow is also finished.

Next, in processing step S1306, the control target calculates the operation amount a based on the control law sent from the output device 120 to the control target, and executes operation. That is, the control target executes operation according to the operation amount a.

Next, in processing step S1307, the control target transmits states of the control target and its surrounding environment measured before and after the execution of the operation to the data reading device 115.

Next, in processing step S1308, the input control unit 141 determines whether or not the data reading device 115 receives data of states of the control target and its surrounding environment measured before and after the execution of the operation. In a case where the data is received, the flow proceeds to processing step S1309, and in a case where the data is not received, the flow returns to processing step S1305.

In processing step S1309, in a case where the data reading device 115 receives data of states of the control target and its surrounding environment measured before and after the execution of the operation in the processing of processing step S1308, the received data and the model data recorded in the model storage unit 131 are transferred to the model update unit 155, and updated model data is recorded in the model storage unit 131. After the above, the flow proceeds to processing step S1302.

### Third Embodiment

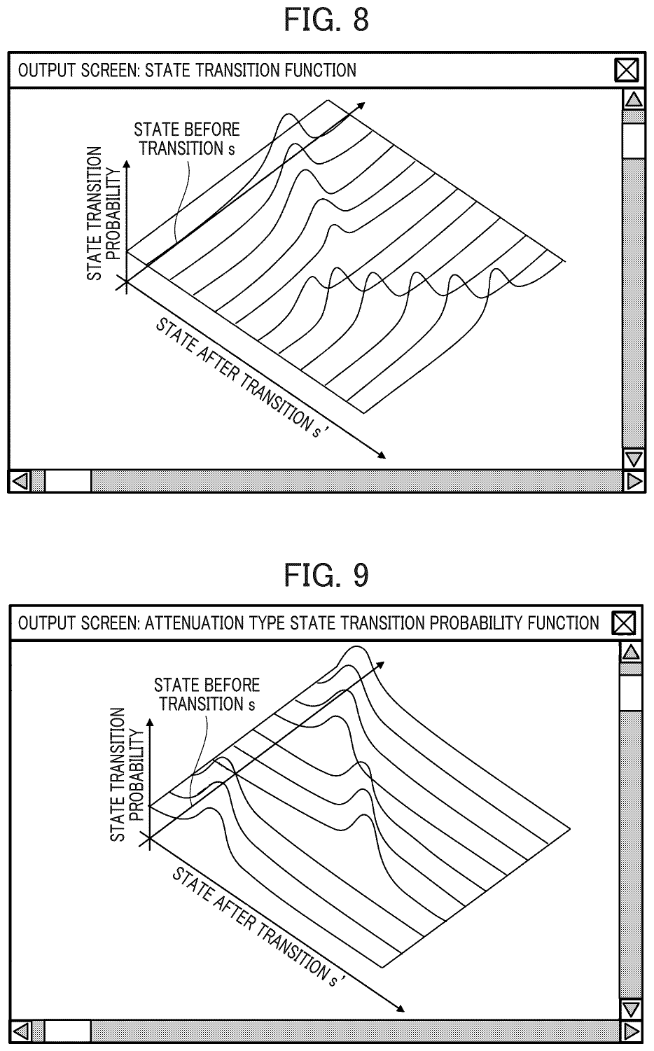

FIGS. 8, 9, and 10 are examples of screens displayed on the output device 120 in First and Second Embodiments.

FIG. 8 illustrates the state transition probability function τ displayed on the screen as an example of model data recorded in the model storage unit 131. In the figure, as an example of a storage format of the model, the state transition probability function τ is displayed on the screen, transition probability from the state before transition s to the state after transition s′ being displayed on the screen in a function format. The transition probability may be able to be updated from this screen through the input device 110.

FIG. 9 illustrates an example of a case where the attenuation type state transition probability function D stored in the future state prediction result storage unit 132 is displayed on the screen. In the figure, the attenuation type state transition probability function D is displayed on the screen in a function format from the state before transition s to the state after transition s′.

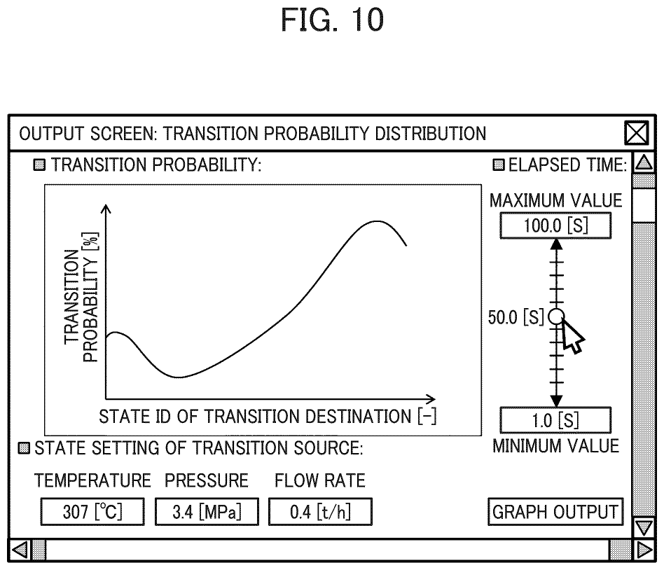

FIG. 10 illustrates an example of a case where the transition probability distribution P is displayed as data obtained by processing model data stored in the model storage unit 131. On the screen, the transition probability P is displayed with the state s′ of a transition destination in the horizontal axis.

The main features of First to Third Embodiments can also be summarized as follows.

The future state estimation apparatus (processing apparatus 100) illustrated in FIG. 1 includes the storage device 130 and the arithmetic device 140. The storage device 130 stores a state transition model in which first state transition probability (state transition probability function τ) representing probability in which a prediction target shifts from a first state s to a second state s′ after elapse of a first time (Δt) is expressed by a linear combination of weighted basis functions (model storage unit 131, Equation (1)). The arithmetic device 140 calculates second state transition probability (attenuation type state transition probability function D, Equation (2)) representing probability in which the prediction target shifts from the first state s to the second state s′ by the time after elapse of a second time (Δt×∞) by product-sum calculation of the weighting matrix ∇ representing a matrix in which weights of the respective weighted basis functions are as elements (future state prediction arithmetic unit 142).

With this, the second state transition probability (attenuation type state transition probability function D) can be calculated by the product-sum calculation of the weighting matrix ∇, not by a multiple integral. As a result, the future state of the prediction target can be rapidly estimated in a form of transition probability distribution within space in a continuous state.

In the present embodiment, the product-sum calculation is calculation of a series of the weighting matrix ∇ (Equations (1), (2)), and the wording “after elapse of the second time” denotes “after elapse of infinite time” or “after elapse of an infinite step”. With this, the state of the prediction target after elapse of infinite time or after elapse of an infinite step can be rapidly estimated.

The arithmetic device 150 illustrated in FIG. 6 calculates the optimal operation amount a of a device controlling the prediction target based on the second state transition probability (attenuation type state transition probability function D) (control law arithmetic unit 154). With this, the operation amount optimal for the control target can be statistically estimated.

The arithmetic device 140 illustrated in FIG. 1 calculates the element value λij of the weighting matrix A from time series of a measurement value of the prediction target by using the optimization method such as, for example, a neural network. With this, the element value Δij of the weighting matrix ∇ can be fed back to the state transition model.

The arithmetic device 150 illustrated in FIG. 6 updates the state transition model by using the element value λij of the weighting matrix ∇ (model update unit 155). The arithmetic device 150 may learn the element value λij of the weighting matrix ∇ by using, for example, deep learning, and update the state transition model by using the learned element value of the weighting matrix. With this, the accuracy of the state transition model can be improved.

The future state estimation apparatus (processing apparatus 100) illustrated in FIG. 1 includes the output device 120. The arithmetic device 140 may cause the output device 120 to output information representing any two or more of the state transition model before update, the state transition model after update, and a difference between the state transition models before and after update (output control unit 143). It should be noted that the state transition model is displayed as illustrated in, for example, FIG. 8.

With this, it is possible to visibly confirm how the state transition model is changed by update.

The arithmetic device 140 may cause the output device 120 to output probability of transition from a state of a transition source to a state of a transition destination in any one or more of an elapsed time, an elapsed step, a time range, and a step range. It should be noted that in the example of FIG. 10, the designated elapsed time and the transition probability in the state of the transition source are displayed as a continuous function of the state of the transition destination.

With this, the transition probability distribution of the prediction target in the designated elapsed time can be visibly confirmed.

In the present embodiment, the basis function is a radial basis function. With this, the first state transition probability (state transition probability function τ) can be expressed by a matrix.

In the present embodiment, the radial basis function is a normal distribution function. With this, for example, the element ψij of the conversion matrix ψ is a constant that does not depend on the first state s and the second state s′.

The arithmetic device 140 stores, in the storage device 130 (for example, memory), probability in which the prediction target shifts from the first state s to the second state s′ after elapse of time of the integral multiple (L) of the first time (Δt), and calculates the second state transition probability (attenuation type state transition probability function D, Equation (2)) from the sum of values obtained by multiplying respective probability stored in the storage device 130 by an exponentiation of the attenuation rate γ according to elapse of time (future state prediction arithmetic unit 142).

With this, the second state transition probability (attenuation type state transition probability function D) can be calculated by the product-sum calculation of the weighting matrix ∇.

The arithmetic device 140 stores, in the storage device 130, a matrix γtψ∇ in which the product of the transposition matrix tψ of the conversion matrix ψ in which an integration value of the normal distribution function is the element ψij and the weighting matrix ∇ is multiplied by the attenuation rate γ, and calculates the second state transition probability (attenuation type state transition probability function D, Equation (4)) based on an inverse matrix of a difference between the unit matrix E and the matrix γtψ∇ stored in the storage device 130 (future state prediction arithmetic unit 142).

With this, even if the state s is continuous, the second state transition probability (attenuation type state transition probability function D) can be calculated by the product-sum calculation of the weighting matrix ∇.

In detail, the arithmetic device 140 calculates the second state transition probability (attenuation type state transition probability function D, Equation (4)) from a Frobenius inner product of the product of the weighting matrix ∇ and an inverse matrix (E-γtψ∇)⁻¹ and a Gaussian function matrix G (future state prediction arithmetic unit 142).

The arithmetic device 140 is installed in a plant (for example, a power generation plant, a chemical plant, and the like), and calculates an operation amount of a device (for example, a steam generator, a vaporizer, and the like) controlling the prediction target (temperature, pressure, and the like). With this, the production efficiency of the plant can be improved.

In the present embodiment, the weighting matrix ∇ is a matrix, but may be a vector. It should be noted that a matrix of one row and N columns or N rows and one column can also be referred to as a vector. The prediction target is a physical amount (temperature, pressure, and the like) of a target (for example, steam) controlled by the device of the plant or a surrounding environment (for example, air) of the target (steam). With this, the distribution of the future state of the surrounding environment can also be rapidly estimated.

It should be noted that the present invention is not limited to the examples described above, and includes various modification examples. For example, the above-described embodiments have been described in detail in order to facilitate the understanding of the present invention, and the present invention is not necessarily limited to those including all of the described configurations. In addition, part of the configuration of one example can be replaced with the configurations of other examples, and in addition, the configuration of the one example can also be added with the configurations of other examples. In addition, part of the configuration of each of the examples can be subjected to addition, deletion, and replacement with respect to other configurations.

In addition, one part or all of the above respective configurations, functions, and the like may be achieved by hardware by, for example, designing by an integrated circuit, or the like. In addition, the above respective configurations, functions, and the like may be achieved by software in such a manner that the processor interprets and executes a program achieving each function. Information of a program, a table, a file, and the like achieving each function can be placed on a recording device such as a memory, a hard disk, and an SSD, or on a recording medium such as an IC card, an SD card, and a DVD.

It should be noted that the embodiments of the present invention may have the following aspects. An object of the following aspects is to provide means for rapidly estimating a state of an operation target or its surrounding environment in infinite time ahead in a form of probability density distribution within space in a finite and continuous state defined in advance.

[1]. A future state estimation apparatus includes a model storage unit that stores a state transition model expressing a characteristic of state transition probability of an operation target or a surrounding environment of the operation target by a linear combination of weighted functions, receives, as an input, a signal in which a weight of the weighted function is made into a matrix or a vector, and estimates a future state of the operation target or the surrounding environment of the operation target in a form of probability density distribution by product-sum calculation of a weighting matrix or a vector.

[2]. In the future state estimation apparatus according to [1], the future state of the operation target or the surrounding environment of the operation target in infinite time or an infinite step ahead is estimated in a form of probability density distribution by calculation of a series of the weighting matrix or the vector.

[3]. In the future state estimation apparatus according to [1] or [2], an optimal operation amount arithmetic unit is provided that calculates an optimal operation amount on the basis of the probability density distribution of the future state of the operation target or the surrounding environment of the operation target.

[4]. In the future state estimation apparatus according to any one of [1] to [3], a learning unit is provided that calculates each element value of the weighting matrix or the vector from time series data that records a characteristic of state transition of the operation target or the surrounding environment of the operation target or information including the characteristic.

[5]. In the future state estimation apparatus according to any one of [1] to [3], a model update unit is provided that updates information of the model storage unit from time series data that records a characteristic of state transition of the operation target or the surrounding environment of the operation target or information including the characteristic.

[6]. In the future state estimation apparatus according to [4], a model update unit is provided that updates information of the model storage unit from each element value of the weighting matrix or the vector calculated by the learning unit.

[7]. In the future state estimation apparatus according to any one of [1] to [6] including display means, any two or more of a model before update, a model after update, and information regarding a difference between the models before and after update are outputted to the display means.

[8]. In the future state estimation apparatus according to any one of [1] to [6] including display means, probability of transition from a state of a transition source to each state in any one or more of a designated elapsed time, elapsed step, time range, and step range is displayed on the display means.

According to [1] to [8], a future state of an operation target in infinite time ahead can be calculated in a form of probability density distribution in a continuous state without depending on time to the future state to be predicted. By using this calculation result, a method of calculating an optimal control law considering a future state in infinite time ahead can be provided. In addition, it is possible to provide a path optimization method considering all paths that can be present in the automatic designing field, a price decision method considering a distant future state in the finance field, and a metabolic path optimization method considering all paths in a range enabling modeling in the bioengineering field.

### LIST OF REFERENCE SIGNS

100: processing apparatus
101: processing apparatus
110: input device
115: data reading device
120: output device
130: storage device
131: model storage unit
132: future state prediction result storage unit
133: reward function storage unit
134: control law storage unit
140: arithmetic device
141: input control unit
142: future state prediction arithmetic unit
143: output control unit
150: arithmetic device
151: input control unit
152: future state prediction arithmetic unit
153: output control unit
154: control law arithmetic unit
155: model update unit

1. A future state estimation apparatus comprising:
a storage device that stores a state transition model in which first state transition probability representing probability in which a prediction target shifts from a first state to a second state after elapse of a first time is expressed by a linear combination of weighted basis functions; and
an arithmetic device that calculates second state transition probability representing probability in which the prediction target shifts from the first state to the second state by the time after elapse of a second time, by product-sum calculation of a weighting matrix representing a matrix in which weights of the respective weighed basis functions are as elements.

2. The future state estimation apparatus according to claim 1,
wherein the product-sum calculation is calculation of a series of the weighting matrix, and
wherein the wording “after elapse of the second time” denotes “after elapse of infinite time” or “after elapse of an infinite step”.

3. The future state estimation apparatus according to claim 1,
wherein the arithmetic device calculates an optimal operation amount of a device controlling the prediction target based on the second state transition probability.

4. The future state estimation apparatus according to claim 1,
wherein the arithmetic device calculates an element value of the weighting matrix from time series of a measurement value of the prediction target.

5. The future state estimation apparatus according to claim 4,
wherein the arithmetic device updates the state transition model by using the element value of the weighting matrix.

6. The future state estimation apparatus according to claim 4,
wherein the arithmetic device learns the element value of the weighting matrix, and updates the state transition model by using the learned element value of the weighting matrix.

7. The future state estimation apparatus according to claim 5, further comprising an output device,
wherein the arithmetic device causes the output device to output information representing any two or more of the state transition model before update, the state transition model after update, and a difference between the state transition models before and after update.

8. The future state estimation apparatus according to claim 1, further comprising an output device,
wherein the arithmetic device causes the output device to output probability of transition from a state of a transition source to a state of a transition destination in any one or more of an elapsed time, an elapsed step, a time range, and a step range.

9. The future state estimation apparatus according to claim 1,
wherein the basis function is a radial basis function.

10. The future state estimation apparatus according to claim 9,
wherein the radial basis function is a normal distribution function.

11. The future state estimation apparatus according to claim 10,
wherein the arithmetic device stores, in the storage device, probability in which the prediction target shifts from the first state to the second state after elapse of time of an integral multiple of the first time, and calculates the second state transition probability from the sum of values obtained by multiplying respective probability stored in the storage device by an exponentiation of an attenuation rate according to elapse of time.

12. The future state estimation apparatus according to claim 10,
wherein the arithmetic device stores, in the storage device, a matrix in which the product of a transposition matrix of a conversion matrix in which an integration value of the normal distribution function is as an element and the weighting matrix is multiplied by an attenuation rate, and calculates the second state transition probability based on an inverse matrix of a difference between a unit matrix and the matrix stored in the storage device.

13. The future state estimation apparatus according to claim 12,
wherein the arithmetic device calculates the second state transition probability from a Frobenius inner product of the product of the weighting matrix and the inverse matrix and a Gaussian function matrix.

14. The future state estimation apparatus according to claim 1,
wherein the arithmetic device is installed in a plant, and calculates an operation amount of a device controlling the prediction target.

15. The future state estimation apparatus according to claim 14,
wherein the weighting matrix is a matrix or a vector, and
wherein the prediction target is a physical amount of a target controlled by the device or a surrounding environment of the target.
